(19) United States
(12) Patent Application Publication
(10) Pub. No.: US 2022/0266624 A1
(43) Pub. Date: Aug. 25, 2022

(54) REPAINT TRAY

(71) Applicant: BILLIE KAY INGALLS ASMUS, HAMPTON, IA (US)

(72) Inventor: BILLIE KAY INGALLS ASMUS, HAMPTON, IA (US)

(21) Appl. No.: 17/676,620

(22) Filed: Feb. 21, 2022

Related U.S. Application Data
(60) Provisional application No. 63/152,673, filed on Feb. 23, 2021.

(51) Int. Cl. B44D 3/12

(52) U.S. Cl. CPC B44D 3/126

(57) ABSTRACT

Example embodiments generally relate to tools employed to apply paint. More specifically, some example embodiments pertain to containers or trays that make paint available for application and provides a means for easy maintenance and clean up of those trays.

### CROSS-REFERENCE TO RELATED APPLICATION(S)

This application claims the benefit of U.S. Provisional Patent Application No. 63/152,673 which was filed with the United States Patent and Trademark Office on Feb. 23, 2021, the entire contents of which are herein incorporated by reference.

### BACKGROUND

### 1. Field

Example embodiments generally relate to tools employed to apply paint. Some example embodiments pertain to containers or trays that make paint available for application and provides a means for easy maintenance and clean-up of those trays.

### 2. Description of the Related Art

Paint has long been applied as a surface coating, primarily for protective and decorative purposes. Paint can be applied in myriad ways, and can be comprised of flat paint, reflective paint, textured paint, weather proof paint, water-based or oil-based to name but a few. Applicators can be as simple as a manual hand-held brush or roller, or pneumatic electric powered spray guns, or aerosol-pressured pump sprays.

In certain applications, applying paint with hand rollers and hand brushes, although tedious, is often the method preferred by professionals and novices alike. Hand brushes and manual rollers are simple to operate and allow the user to more easily and simply manage and control the volume and thickness of the application of the paint onto the surface. However, as anyone who has painted using a brush or roller knows, it is necessary to have a source of paint that is conveniently positioned near where the painter is painting. The paint source may simply be a container of paint into which one dips a paintbrush to accumulate paint to brush on a surface. Alternatively, one may employ what is known as a paint tray. The paint tray typically has a floor to support the tray while sitting on a surface. The floor has a perimeter and includes a first portion that is parallel to the surface on which the paint tray is positioned and a second portion that is angled or slopes upward relative to the first portion. One or more support legs may be provided to support the upward angled second portion. Sides may be angled or generally perpendicular relative to the floor and positioned at or near or along the floor's perimeter thereby forming a well into which paint can be poured. With adequate paint in the well, a roller can be loaded with paint. In some embodiments the paint tray is equipped with feet or a brace to steady the paint tray during use.

Paint trays are an important painting tool because they can be proportioned to accommodate all sizes of rollers and brushes and help speed the work of painting. Still, paint trays have some drawbacks. Paint trays, for example, are generally prone to paint splashes and spills. Paint trays, also, can load the paint roller unevenly, making work tedious and sometimes delaying it as the painter takes the time to even the application to the roller by running it back and forth along the ramped portion of the tray before applying it to the wall or other surface. But one of the most challenging problems for painters employing paint trays is that paint trays can collect various foreign debris, such as old plaster, paint, and insects. These materials may then become applied with the paint accidentally and can disturb the coating of paint applied to a wall, leaving visible flaws. Therefore, it is important to avoid those contaminants.

To prevent paint flaws due to debris in the paint contaminating the paint supply, for years paint users have employed various means to clean a paint tray. Cleaning a tray well enough to avoid contaminating the next volume of paint it accommodates can be challenging. Several different ways to clean a paint tray have been used with varying levels of success. Some employ soap and water, some use paint thinner, and some favor power washing. While these methods can be relatively effective, they are tedious and time consuming. Further, to be effective, these methods need to be used before the paint accidentally applied to the paint tray and other equipment gets so dry that it cannot be fully removed, or at least not easily removed.

As an alternative to the work required to clean a paint tray, some choose to use a paint tray liner. Liners are available at most hardware stores and are used to prevent trays from getting dirty or paint spilled on the trays in the first place.

### SUMMARY

Conventional liners do an adequate of keeping a paint tray clean and free of defects. However, conventional liners are intended as single-use items and are not sturdy enough to be cleaned and re-used, and are not made of material which can be easily cleaned for additional uses. This means using these liners adds expense to every project and increases waste material. Further, these trays are not typically made of material that can be recycled. Thus, there was a need to develop a product that solves these problems.

The present innovation comprises an innovative paint liner device that is designed to provide a convenient and effective means of removing leftover dried paint and incorporating other problem-solving features.

Example embodiments provide a liner member for the paint tray. In at least one nonlimiting example embodiment the liner member includes a flexible body having a front wall, a back wall, a floor, and two side walls. In at least one example embodiment, the front wall is shorter than the back wall and the depths of the side walls vary along a length of the liner member. In one embodiment the flexible body has a well near the back wall and the well has a substantially flat bottom surface. In this nonlimiting example embodiment, the flexible body may have a slanted section and the slanted section may include structures for distributing paint. In one embodiment the structures are chevrons, in another embodiment the structures are detents. In example embodiments, the flexible body may be comprised of an elastic material, for example, silicone, allowing the body to easily deform.

### BRIEF DESCRIPTION OF THE DRAWINGS

Example embodiments are described in detail below with reference to the attached drawing figures, wherein:

FIG. 1 is a perspective view of an exemplary paint liner device comprised of a main liner member and a conventional paint tray in accordance with example embodiments;

FIG. 2 is a perspective view of an exemplary paint liner device with the main liner member and the conventional paint tray illustrated as separate components in accordance with example embodiments;

FIG. 3 is a perspective view of a conventional paint tray in accordance with example embodiments;

FIG. 4 is a perspective view of an exemplary main liner member in accordance with example embodiments;

FIG. 5 is a top view of the exemplary main liner member in accordance with example embodiments;

FIG. 6 is a side view of the exemplary main liner member in accordance with example embodiments;

FIG. 7 is bottom perspective view of the exemplary main liner member in accordance with example embodiments;

FIG. 8 is another exemplary main liner member in accordance with example embodiments;

FIG. 9 is a perspective/exploded view of an exemplary paint liner device comprised of a main liner member, a conventional paint tray, and a lid in accordance with example embodiments; and

FIG. 10 is a side view of an exemplary paint liner device comprised of a main liner member, a conventional paint tray, and a lid in accordance with example embodiments.

### DETAILED DESCRIPTION

Example embodiments will now be described more fully with reference to the accompanying drawings. Example embodiments are not intended to limit the invention since the invention may be embodied in different forms. Rather, the example embodiments are provided so that this disclosure will be thorough and complete, and will fully convey the scope of the invention to those skilled in the art. In the drawings, the sizes of components may be exaggerated for clarity.

In this application, when an element is referred to as being “on,” “attached to,” “connected to,” or “coupled to” another element, the element may be directly on, directly attached to, directly connected to, or directly coupled to the other element or may be on, attached to, connected to, or coupled to any intervening elements that may be present. However, when an element is referred to as being “directly on,” “directly attached to,” “directly connected to,” or “directly coupled to” another element or layer, there are no intervening elements present. In this application, the term “and/or” includes any and all combinations of one or more of the associated listed items.

In this application, the terms first, second, etc. are used to describe various elements and components. However, these terms are only used to distinguish one element and/or component from another element and/or component. Thus, a first element or component, as discussed below, could be termed a second element or component.

In this application, terms, such as “beneath,” “below,” “lower,” “above,” “upper,” are used to spatially describe one element or feature's relationship to another element or feature only as illustrated in the figures. However, in this application, it is understood that the spatially relative terms are intended to encompass different orientations of the structure. For example, if the structure in the figures is turned over, elements described as “below” or “beneath” other elements would then be oriented “above” the other elements or features. Thus, the term “below” is meant to encompass both an orientation of above and below. The structure may be otherwise oriented (rotated 90 degrees or at other orientations) and the spatially relative descriptors used herein interpreted accordingly.

Example Embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate tools employed to apply paint. More specifically, the invention pertains to containers or trays that make paint available for application and provides means for easy maintenance and clean up of those trays.

An example of the present invention provides a tray liner configured to prevent paint from contacting a paint tray. In one nonlimiting example embodiment, the tray liner is a flexible tray liner which allows a user to deform the tray liner. For example, the tray liner may be comprised of, or entirely consist of, silicone. That is, an example paint tray liner may be a silicon paint tray liner. Regardless, paint in the inventive liner can be allowed to dry and can then be easily removed with ease and without the usual mess. In one embodiment, removal of the dried paint is accomplished by flexing the paint tray and the inventive liner; the flex causes the separation of the liner from the paint, leaving the paint relatively easy to peel or become easily peeled from the liner, taking any dried paint with the peeled paint and leaving a generally clean tray. In another embodiment, a non-flexible tray may be employed; in this situation, after the paint dries on the inventive paint tray liner, a corner of the paint tray liner may be lifted to remove and peel the liner from the tray, taking with it leftover dried paint. Once the paint is peeled from the tray liner, the tray liner is ready to be reused.

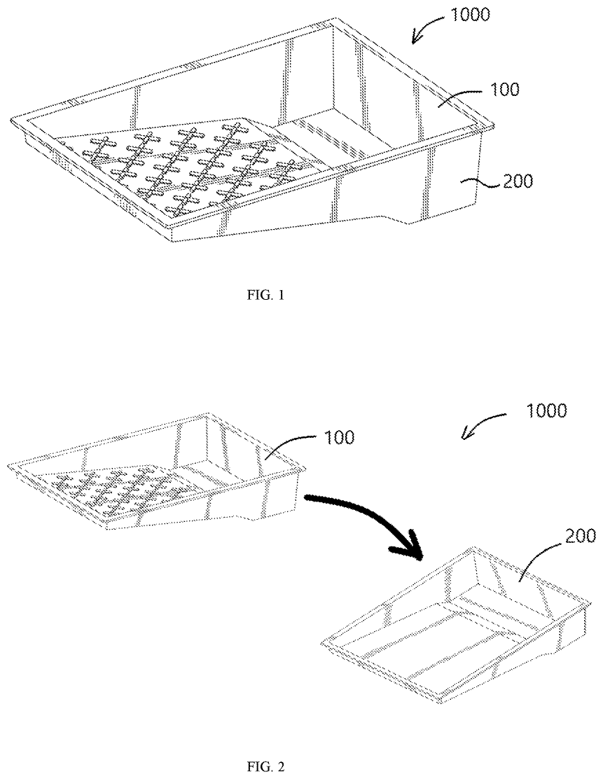

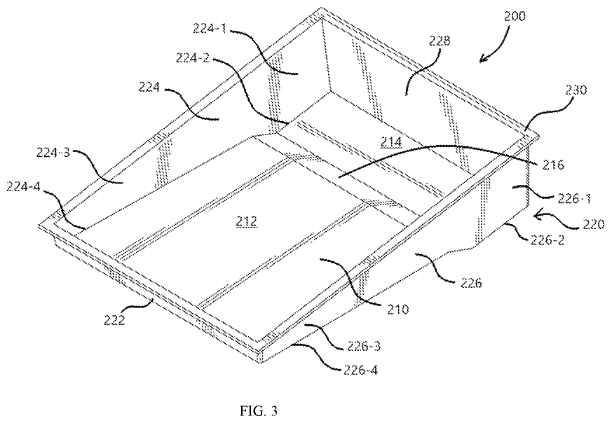

FIGS. 1 and 2 show an exemplary paint liner device 1000 comprised of a main liner member 100 and a conventional paint tray 200. More specifically, FIG. 1 shows the main liner member 100 nested in the conventional paint tray 200 and FIG. 2 shows the main liner member 100 separated from the conventional paint tray 200 to show that, in this embodiment, the main liner member 100 and the conventional paint tray 200 are distinctive components of the paint liner device 1000. The main liner member 100 can be made in various forms to accommodate most commercially available paint trays. The exemplary conventional paint tray 200, as best shown in in FIG. 3, may comprise a floor 210, a plurality of walls 220, and a lip 230. The floor 210 may have a generally sloped section 212 and a relatively deep section 214 which may accommodate paint (albeit indirectly). That is, in use, the relatively deep section 214 may function a well for paint. Between the deep section 214 and the sloped section 212 is a transition section 216 which may resemble an inclined surface having a different slope than the sloped section 212. In use, a bottom surface of the relatively deep section 214 may be parallel with the ground and the sloped section 212 may be sloped such that paint on the sloped section 212 may flow towards the relatively deep section 214 under the influence of gravity.

As shown in FIG. 3, the plurality of walls 220 may extend from the floor 210. In one embodiment the walls 220 extend vertically, in another embodiment, one or more of the walls 220 are inclined. As shown in FIG. 3, the walls 220 may include a front wall 222, two side walls 224 and 226, and a back wall 228. As shown in FIG. 3, the front wall 222 may have a shorter depth than the back wall 228 and the side walls 224 and 226 may have a depth that varies from the front wall 222 to the back wall 228. For example, back portions 224-1 and 226-2 of the sidewalls 224 and 226 may have lower surfaces 224-2 and 226-2 that are somewhat horizontal whereas front portions 224-3 and 226-3 of the sidewalls 224 and 226 may have lower surfaces 224-4 and 226-4 that are inclined.

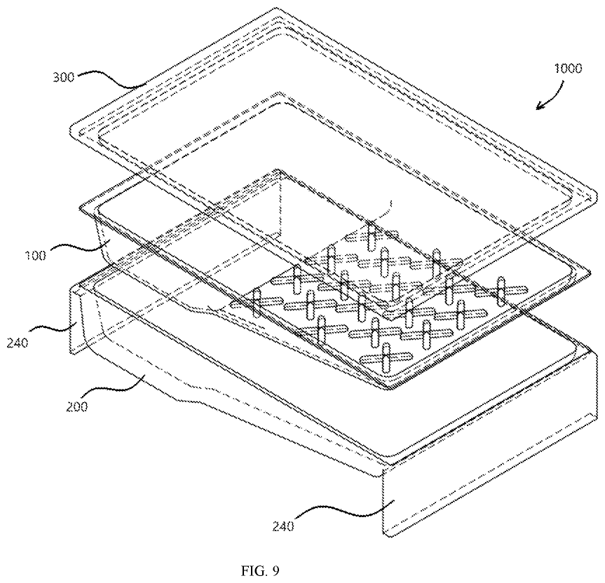

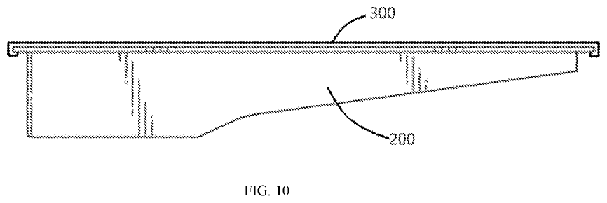

In example embodiments, the conventional paint tray 200 may include additional features. For example, as shown in FIG. 3, the exemplary paint tray 200 may include a perimeter having the lip 230 and the lip 230 may be at the top of the walls 220. The perimeter/lip 230 may be, but is not required to be, a substantially continuous and flat surface which may be parallel with the ground when the conventional paint tray 200 is in use. Additionally, referring to FIG. 9, the conventional paint tray 200 may include one or more feet 240. The feet 240 may support and stabilize the paint tray 200 when the paint tray is in use.

In example embodiments, the conventional paint tray 200 may be formed as one structure from a process such as, but not limited to, casting, however, the invention is not limited thereto. For example, while the floor 210, walls 220, and lip 230 maybe be formed by a casting process, the feet 240 may be added by another process such as welding or gluing the feet 240 to one or more of the floor 210, walls 220, and lip 230. This description, of course, is exemplary in nature and is not meant to limit the invention.

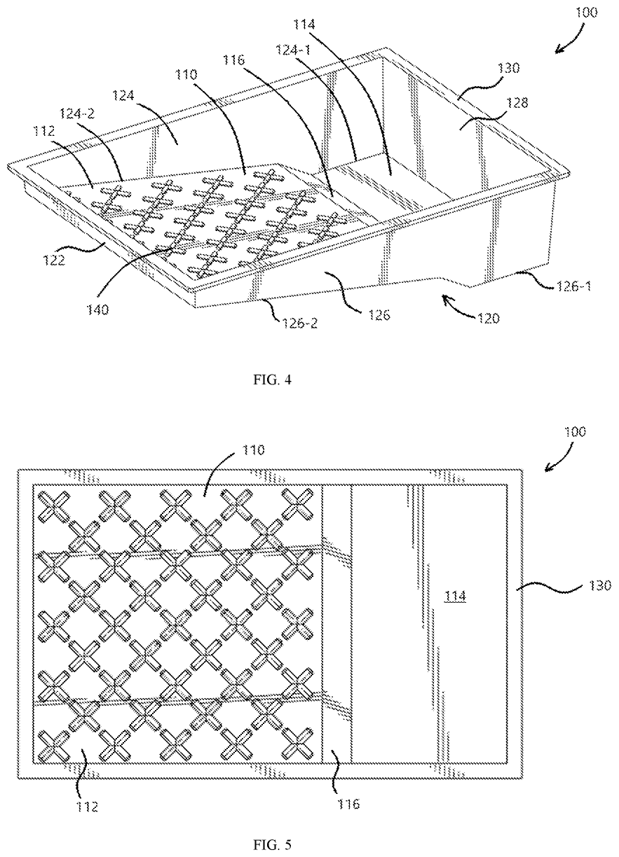

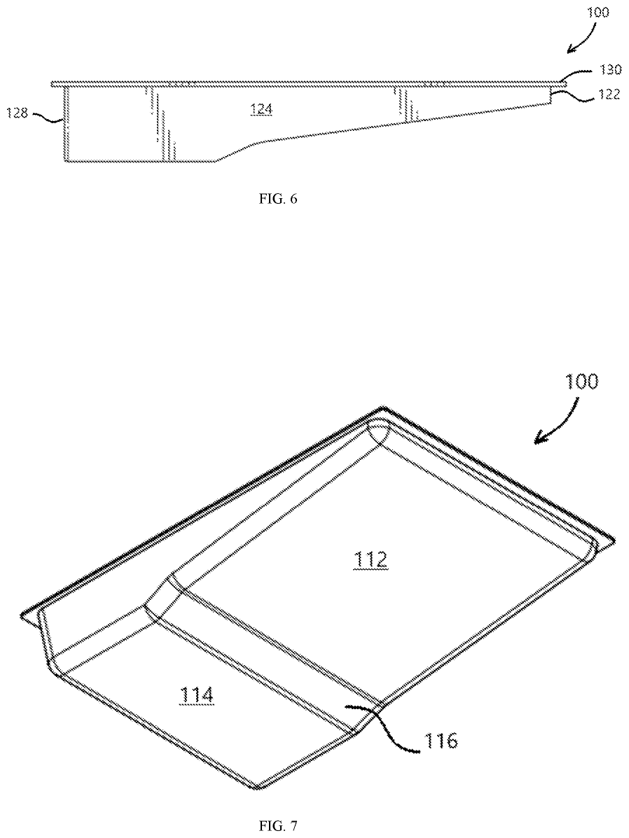

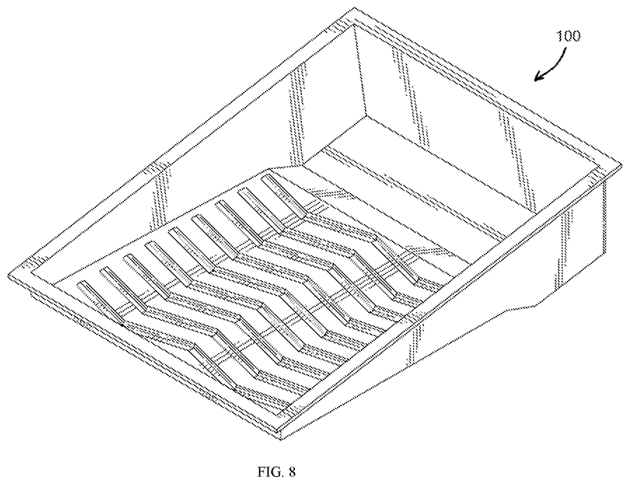

Turning now to FIGS. 4-7, an example of the main liner member 100 is described. The exemplary main liner member 100, as shown in FIGS. 4-7, may comprise a floor 110, a plurality of walls 120, and a lip 130. The floor 110 may have a generally sloped section 112 and a relatively deep section 114 which may directly accommodate paint. That is, the relatively deep section 114 may function a well for paint. Between the deep section 114 and the sloped section 112 is a transition section 116. In use, a bottom surface of the relatively deep section 114 may be parallel with the ground and the sloped section 112 may be sloped such that paint on the sloped section 112 may flow towards the deep section 114 under the influence of gravity.

As shown in FIGS. 4-7, the walls 120 of the main liner member 100 may extend from the floor 110. In one embodiment the walls 120 may extend vertically, in another embodiment, one or more of the walls 120 are inclined. As shown in FIGS. 4-7, the walls 120 may include a front wall 122, two side walls 124 and 126, and a back wall 128. The front wall 122 may have a shorter depth than the back wall 128 and the side walls 124 and 126 may have a depth that varies from the front to the back of the main liner member 100. For example, back portions of the sidewalls 124 and 126 may have lower surfaces 124-1 and 126-1 that are somewhat horizontal whereas front portions of the sidewalls 124 and 126 may lower surfaces 124-2 and 126-2 that are inclined.

In example embodiments, the lip 130 of the main liner member 100 may be at the top of the walls 120. The lip 130 may be, but is not required to be, a substantially continuous and flat surface which may be parallel with the ground in use. When the main liner member 100 is placed in the paint tray 200, the lip 130 of the main liner member 100 may rest on the lip 230 of the paint tray 200. This may create a seal which helps prevent paint in the main liner member 100 from flowing into the paint tray 200 and prevent spilling.

In addition to the aforementioned description, the main liner member 100 may include additional features. For example, as shown in at least FIG. 4, the sloped section 112 of the floor 110 may include structures 140, for example, bumps or some other structure, which aids in spreading paint and removing paint. For example, in use, a roller may be placed in the relatively deep section 114 of the main liner member 100 which may have paint therein. As is conventional, the roller may be rolled backwards and over the sloped section 112. The structures 140 may help remove excess paint or allow paint to spread evenly across the roller. The structures 140, in one embodiment, may be “X” shaped as shown in FIG. 4, or chevron shaped, as shown in FIG. 8 (noting the main liner member 100 of FIG. 8 is substantially the same as the main liner member 100 of FIGS. 4-7 except for the shape of the structures 140).

In example embodiments the structures 140 are shown on a top surface of the floor 110. In this embodiment, the structures may help remove excess paint from a roller or help spread paint evenly across the roller. In another embodiment, the structures 140 may be placed on a bottom surface of the floor 110. That is, the structures may resemble bumps, for example, X-shaped bumps or chevrons which protrude from a bottom surface of the floor 110. In this latter embodiment, the structures 140 may help the liner 100 better adhere to the paint tray 200 by increasing a friction between the main liner member 100 and the paint tray 200. In another embodiment, the structures 140 may be on the bottom and top surfaces of the floor 110.

In use the main liner member 100 is nested in the paint tray 200 as shown in FIG. 1. In some embodiments, the lip 130 of the main liner member 100 rests directly on the lip 230 of the paint tray 200. The main liner member 100 may be sized such that the outer dimensions of the main liner member 100 facing the paint tray 200 are substantially the same (albeit it slightly smaller) as the inner dimensions of the paint tray 200 facing the main liner member 100. However, some tolerance is permissible. Furthermore, in example embodiments the main liner member 100 may be made of a flexible material, for example, silicon, so that as paint in poured into the main tray liner 100, the main tray liner 100 can flex and deform into the paint tray 200.

In example embodiments the main liner member 100 may be formed as a unitary structure. For example, the main liner member 100 may be made from a casting or a molding process. Regardless, in example embodiments, the main liner member 100 is fabricated from a flexible material such as, but not limited to, silicon. Thus, the structure of the main liner member 100 is different from conventional liners in that the main train liner 100 is very flexible. For example, as shown in FIGS. 10-12, the main liner member 100 may be easily bent and stretched. This allows for any dried paint, which may be less deformable than the main liner member 100, to peel off the main liner member 100. The flexibility of the main liner member 100 allows the main liner member 100 to be easily cleaned. Furthermore, because the main liner member 100 is easily deformable, it can be stored in a deformed state. For example, in one embodiment, the main liner member 100 may be rolled up and moved from one place to another in a person's pocket or rolled up and placed in a toolbox.

Use of the paint tray 200 and main liner member 100 just described includes placing the main liner member 100 into the paint tray 200 and pouring paint into the tray well (i.e., the relatively deep section 114 of the main liner member 100). Thereafter, when the painting task is complete, excess paint can be poured off. As is typical, some paint may remain after attempting to empty the paint liner device 1000. If no main liner member 100 was employed, the user is faced with the unenviable task of trying to dissolve or scrape dried paint to enable its removal from the tray 200. If a prior art liner was used, then the prior art liner can be removed but must be properly disposed of or, if the prior art liner is a reusable liner, then it must be cleaned in order to re-use it, and the remaining paint must be properly disposed. The excess paint remaining in a prior art liner that is not easily poured back into a container needs to be immediately cleaned out of a prior art reusable liner to prevent bonding of paint to the prior art liner which may prevent its re-use. Or, if paint is allowed to dry in the prior art liner, the user must clean the prior art tray liner in order to re-use it and such cleaning can be a difficult task. Further, in prior art paint trays, the paint dried in the tray can be almost impossible to remove from the liner and/or the tray because the paint has typically become firmly affixed to the prior art liner or tray and anything else it has been spilled, wiped, or painted on. Example embodiments disclosed herein solves the aforementioned problem. Even if paint is forgotten and left in the inventive main liner member 100, due to its construction and materials, it will not ruin the main liner member 100 and can be removed days or even months later. Specifically, the inventive main liner 100 does not bond with the paint therefore allowing the paint remaining in the main liner member 100, once dried, to be simply peeled off the main liner member 100.

The main liner member 100 can be made in any shape and size suitable for fitting into the intended paint tray 200. When properly assembled, the main liner member 100 nests on top of the paint tray 200. The main liner member 100 is configured to fit the contours of the respective paint trays 200 that can be used with the example embodiments.

The main liner member 100 in some example embodiments, is generally a paint receptacle with a unitary structure and may include substantially or generally vertical front 122, sides 124 and 126, and back wall 128 portions whose upper margins define an opening. The bottom portion of the main liner member 100 may include a sloped portion 112 with a plurality of detents (see FIG. 8, for example) to help keep the liner 100 in position relative to the floor 212, for assisting the user in the removal of excess paint, and to assist with uniform paint loading. In one embodiment, the bottom portion of the main liner member 100 may include a deep recess area (formed by sidewalls 124,126 floor 114, and transition section 116) on one end and a shallow area (formed by sidewalls 124,126 floor 112, and upper edge of transition section 116) on an end opposite the deep recess area 114.

In another embodiment, the bottom portion of the main liner member 100 may include an upward-facing reservoir (formed by sidewalls 124,126, floor 114, and transition section 116) near the back wall 128 for receiving and holding paint. The bottom portion may include a slanted surface 112 that extends from one end near the reservoir 300 to the other end of the main liner member 100. The slanted surface 112 may serve as a roll-off surface for a roller and include a roll-off pattern that may include multiple raised chevrons (see FIG. 8) or one or more X or plus (+) signs (140, see at least FIG. 4) so that when the paint roller is covered with paint in the reservoir area of the main liner member 100 and then rolled toward the shallow area of the main liner member 100, the treads help distribute the paint more or less evenly over the roller, as is commonly performed in the art. In some embodiments, the reservoir can be positioned between the end of the roll-off surface and the back wall portion, which can be slanted rearward at an angle much steeper than that of the slanted roll-off surface.

The side wall portions of the main liner member may include angled side surfaces that substantially match the angle of the paint tray's inner surfaces.

In some embodiments, exemplary paint liner device 1000 may include a lid 300 in addition to the main liner member 100 and the paint tray 200 (see FIG. 9). The lid 300 may be configured to cover the open top portion of the paint liner member 100. The lid 300 can be made of any suitable material including silicone. In example embodiments the lid 300 may be figured to connect to the paint tray 200. For example, the lid 300 may have a periphery that extends downward with a lip 310 that wraps around the lips 230 of the paint tray 200. FIG. 10, for example, shows the lid 300 attached to the paint tray 200. One skilled in the art would understand a variety of ways the lid 300 may be configured to attach to the tray 200, thus, a detailed explanation is omitted for the sake of brevity.

In some embodiments, the main liner 100 is made out of silicone to fit in a standard metal paint tray 200. A liner 100 of at least one example embodiment may be made of silicone that would allow easy clean-up and be more environmentally friendly by allowing longer use than a standard plastic liner, which typically allows only a one-time use.

In some embodiments, the lip 130 can include an open upper lip 130 that opens downward to cover the upper edge 230 of the paint tray 200. The silicon material of at least one example embodiment will naturally adhere to the paint tray 200 while sitting over the upper edge 230 of the paint tray 200, covering the exposed surface of the paint tray 200 so that it stays in place and does not shift in the paint tray while the user is painting.

The silicon material and unique design used in at least one example embodiment will also help protect the metal tray 200 from paint spillage or drips, keeping the main liner member 100 clean and allowing a longer lifespan.

Although the invention has been explained in relation to one embodiment, it is to be understood that many other possible modifications and variations can be made without departing from the spirit and scope of the invention.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A liner member for the paint tray comprising:
a flexible body having a front wall, a back wall, a floor, and two side walls, wherein the front wall is shorter than the back wall and the depths of the side wall vary along a length of the liner member.

2. The liner member of claim 1, wherein the flexible body has a well near the back wall, the well having a substantially flat bottom surface.

3. The liner member of claim 1, wherein the flexible body has a slanted section.

4. The liner member of claim 1, wherein the slanted section includes structures for distributing paint.

5. The liner member of claim 4, wherein the structures are chevrons.

6. The liner member of claim 4, wherein the structures are detents.

7. The liner member of claim 1, wherein the two substantially triangular side walls have a bottom which is substantially horizontal and an inclined section.

8. The liner member of claim 7, where the two substantially triangular side walls have a transition section between the bottom and the inclined section.

9. The liner member of claim 1, wherein the body is comprised of an elastic material.

10. The liner member of claim 1, wherein the body is a unitary body.

11. The liner member of claim 10, wherein the body is comprised of silicone.
